(19) United States
(12) Patent Application Publication
(10) Pub. No.: US 2008/0060712 A1
(43) Pub. Date: Mar. 13, 2008

(54) Turbine inverter

(76) Inventors: Eli Gluzman, Pasadena, CA (US); Stefany Gluzman, Pasadena, CA (US); Vadim Gluzman, Mission-Viejo, CA (US)

Correspondence Address: Eli Gluzman, 273 E. Glenarm Street, Unit 9, Pasadena, CA, 91106, US

(21) Appl. No.: 11/519,701

(22) Filed: Sep. 12, 2006

(51) Int. Cl. F15D 1/04

(52) U.S. Cl. 138/39; 138/42

(57) ABSTRACT

Disclosed is a fluid flow diverting device comprising a hollow main body and a plurality of blades protruding into the interior of the main body. The blades are positioned along the interior surface of the main body in multiple layers. The blades of each successive layer have a larger surface area and a larger entry angle of approach than the blades of a previous layer. The fluid diverting device can be inserted into any enclosed medium where fluids typically flow. The arrangement of blades diverts the flow of fluid in a way that creates a low pressure flow in the center of the enclosed medium. This low pressure flow is surrounded by high pressure flow, resulting in an increase in the swirling of matter and a pull of matter toward the center of the medium.

### FIELD OF THE INVENTION

This invention relates generally to devices for improving the flow of matter (e.g., a gas or liquid) through an enclosed medium (e.g., a tube or duct of variable shapes) by diversion and redirection downstream from the devices, and more particularly, to devices for insertion into tube-like pathways in order to improve fluid flow.

### BACKGROUND OF THE INVENTION

In fluid dynamics, turbulence is a flow regime characterized by chaotic property changes. Flow that is not turbulent is called laminar flow. When a fluid, i.e., liquid or a gas, flows through an enclosed medium with a relatively smooth interior surface, i.e., a pipe or a hose, the flow is typically laminar at very low speeds or low pressure. As the speed or pressure of fluid flow in pipes or hoses increases, as is inevitable during operation of almost all of the presently used machines and devices, laminar flow becomes increasingly more turbulent. In turbulent flow, unsteady vortices appear on many scales and interact with each other. Drag due to boundary layer skin friction increases and turbulence causes the formation of eddies.

Because turbulent fluid flow encounters more resistance and drag as it flows through an enclosed medium, turbulent flow requires a higher input of energy from a pump (or fan) than laminar flow. Although laminar flow is more efficient than turbulent flow, the predominant majority of currently utilized machines and devices depend upon turbulent (high speed) fluid flow to function properly. Examples of such machines and devices include motor vehicles, water piping and air conditioning systems, vacuum cleaners, etc. Because these machines and devices elicit turbulent fluid flow, they all suffer from an inherent inefficiency stemming from the need for additional energy to overcome these flow restrictions. As a result, a number of prior art devices have been implemented to mix, swirl, and/or rotate turbulent fluids in an attempt to increase their speed and flow efficiency.

U.S. Pat. No. 846,751 to Melvin teaches a device for mixing various materials and commodities, such for examples, teas, coffees, or different kinds of flours or meals. The device includes several layers of blades in series which extend from the wall of the interior casing, and the blades of one level are inclined, as to their widths, reversing relatively to the cross-sectional inclination of the blades of the next layer therebelow. The multiple layers of blades of varying inclinations are designed to more thoroughly mix the food as it moves through the device.

U.S. Pat. No. 830,268 to Wheelock, U.S. Pat. No. 1,115,699 to Loose, U.S. Pat. No. 1,345,791 to Livingstone, and U.S. Pat. No. 1,868,902 and U.S. Pat. No. 2,174,266 to Jackson all teach air mixing devices, which include a plurality of flanges wings or blades that extend across the hollow interior of the main body of the devices and that act upon incoming air to deflect and mix the air in order to increase speed or improve the circulation of air.

U.S. Pat. No. 6,928,979 to Chen discloses an air swirling device acting as an engine speed increaser and consisting of an outer circular tube, an inner circular tube of a shorter diameter than that of the outer tube and positioned in the center of the outer tube, and a plurality of twisted leaves positioned spaced apart equidistantly between the outer tube and the inner tube. As air moves through the device, it goes partly straight through the center hollow but mostly gets swirled by the twisted leaves.

U.S. Pat. Nos. 6,932,049, 6,840,212 and 5,113,838 to Kim, U.S. Pat. No. 6,258,144 to Huang, U.S. Pat. No. 6,796,296 to Kim and U.S. Pat. No. 6,536,420 to Cheng relate to a swirling device body mounted in an air cleaner and a plurality of slantingly and radially disposed wings mounted on the swirling device body for accelerating or increasing the air flow revolution. The air swirling device includes non-linear type wave surfaces formed along the upper or lower side of the wing to increase the surface area in contact with the air flow, and each of the wings has at least one or more air flow holes formed at prescribed positions for reducing air flow resistance due to eddy generation at the negative pressure zone of the wing.

U.S. Pat. No. 6,837,213 to Burnett relates to an air swirling cylindrical device containing a plurality of cut and diagonally bent tabs which are in the shape of dog ears, which cause gases fluids to flow out of the device in a clockwise direction during use, i.e., to rotate clockwise as the gases flow downstream.

All of the devices in the prior art suffer from the same inherent disadvantages, namely: (1) the failure to direct the flow of fluid in subsequent steps; (2) the inability to create flow pressure gradients and use them to create a centralized uniform pull effect of matter through an enclosed medium; and (3) the failure to reduce friction and resistance at the point of fluid entry as well as reduce G pressure (eddy) at the mid to end by the blade while keeping fluid diversity and volume capacity at maximum levels. Accordingly, there is a need for a device that is capable of avoiding the disadvantages of the devices of the prior art.

### SUMMARY OF THE INVENTION

The invention satisfies this need. The invention is a turbine inverter having a main body with a hollow cavity and an interior surface. A plurality of curved blades is arranged in a spaced relationship about the interior surface of the main body. The blades project inwardly from the interior surface into the hollow cavity of the main body. The blades are arranged in a plurality of layers, with the blades in each consecutive layer having an incrementally larger surface area and larger entry angle of approach than blades in a preceding layer. The blade layers are adapted to encounter a flowing fluid in succession and directing the flow of said fluid.

In the preferred embodiment of the invention, the turbine inverter comprises three layers of curved blades. However, multiple additional embodiments can be constructed where the turbine inverter comprises more than three layers of curved blades.

The invention is also a method of decreasing the turbulence of fluid flow through an enclosed medium. The method comprises the following steps: providing at least one turbine inverter as described above and placing the turbine inverter into the enclosed medium. This method decreases the turbulence of flow of fluid within the medium.

In one embodiment of the method, one turbine inverter is placed within the medium. In another embodiment of the method, two turbine inverters are placed within the medium at predetermined intervals.

It is a primary objective of the present invention to provide a device which reduces turbulent fluid flow through any enclosed medium.

It is another objective of the present invention to provide a device for creating low pressure fluid flow in the center of the enclosed medium while creating higher pressure fluid flow surrounding the low pressure fluid flow.

It is another objective of the present invention to provide a method of using the device of the present invention in order to reduce turbulent fluid flow in any enclosed medium.

The features, aspects and advantages of the present invention will become better understood with regard to the following description, appended claims and accompanying figures.

### BRIEF DESCRIPTION OF THE DRAWINGS

FIG. 1 is a perspective view of the turbine inverter according to one embodiment of the present invention.

FIG. 2 is a plan view of the turbine inverter during assembly stage as a sheet of metal with cut lines outlining the plurality of blades and their angle of tilt.

FIG. 3 is a plan view of the turbine inverter during assembly stage as sheet of metal after cutting the blades and bending the blades inward, but before final shaping into cylinder form.

FIG. 4 is an antero-lateral view of the turbine inverter illustrated in FIG. 3, taken along line 4-4, illustrating one small blade of the turbine inverter.

FIG. 5 is an antero-lateral view of the turbine inverter illustrated in FIG. 3, taken along line 5-5, illustrating one medium blade of the turbine inverter.

FIG. 6 is an antero-lateral view of the turbine inverter illustrated in FIG. 3, taken along line 6-6, illustrating one large blade of the turbine inverter.

FIG. 7 is antero-lateral view of turbine inverter illustrated in FIG. 3, taken along line 7-7, illustrating the first layer of blades of the turbine inverter.

FIG. 8 is an antero-lateral of turbine inverter illustrated in FIG. 3, taken along line 8-8, illustrating the second layer of blades of the turbine inverter.

FIG. 9 is an antero-lateral of turbine inverter illustrated in FIG. 3, taken along line 9-9 illustrating the third layer of blades of the turbine inverter.

FIG. 10 is an antero-lateral view of the turbine inverter illustrated in FIG. 3.

FIG. 11 is an antero-lateral view of the turbine inverter illustrated in FIG. 3, with the metal sheet partially folded into semi cylinder shape.

FIG. 12 is an antero-lateral view of the sheet of metal illustrated in FIG. 3, with the flow vectors illustrated by arrows, demonstrating fluid flow direction as it approaches and is diverted by the blades of the turbine inverter.

FIG. 13 is an entry view of the turbine inverter, illustrating only the orientation of the small blades.

FIG. 14 is a mid view of the turbine inverter, illustrating only the orientation of the medium blades.

FIG. 15 is an end view of the turbine inverter, illustrating only the orientation of the large blades.

FIG. 16 is a flow entry view of the turbine inverter, illustrating the orientation of the small, the medium and the large blades.

FIG. 17 is a side view perspective side view of the turbine inverter in operation, illustrating the flow of fluid as it moves into and out of the turbine inverter.

### DETAILED DESCRIPTION OF THE PREFERRED EMBODIMENTS

In the following description of the preferred embodiments, reference is made to the accompanying drawings which show by way of illustration specific embodiments in which the invention may be practiced. It is to be understood that other embodiments may be utilized and structural and functional changes may be made without departing from the scope of the present invention.

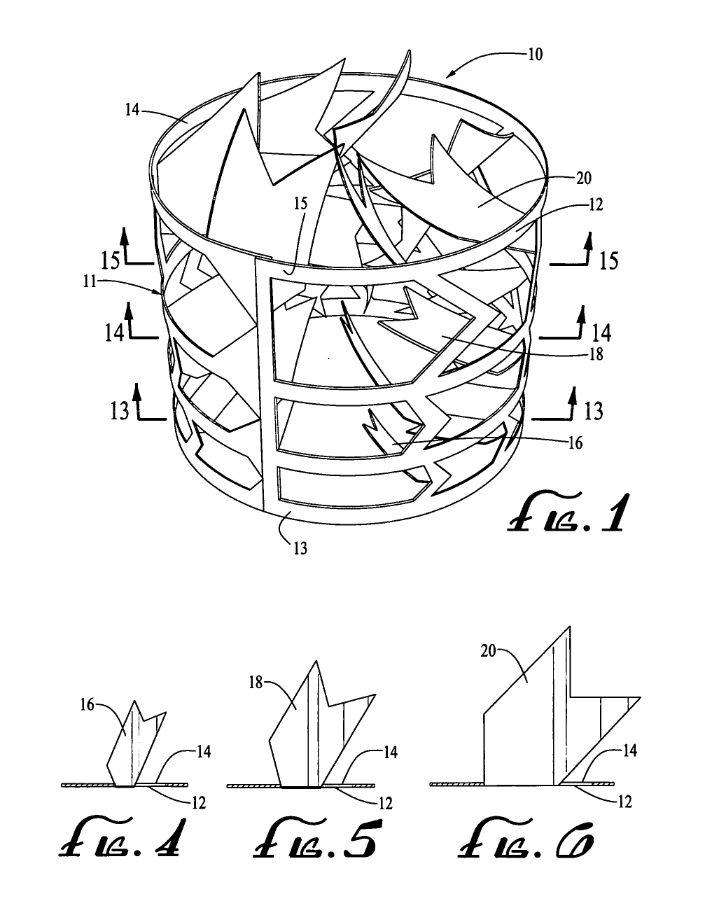

The present invention is a turbine inverter for improving the flow of fluids through any enclosed medium. FIG. 1 illustrates a preferred embodiment of the turbine inverter 10 of the present invention. The turbine inverter 10 has a main body 11. Although the main body 11 is preferably cylindrical, it could be of any suitable shape to complement the shape of the enclosed medium in which the turbine inverter is to be used. An example of such an enclosed medium could be a pipe, a hose, or a similar device typically used to transport fluids.

Referring to FIG. 1, the main body 11 is hollow and has an exterior surface 12, an interior surface 14, a first end 13 and a second end 15. Vanes, also referred to as blades, 16, 18, 20 are fixedly positioned along the interior circumference of the main body 11. The blades 16, 18, 20 project into the hollow of the main body 11.

As illustrated in FIG. 2, the turbine inverter 10 of the present invention is typically manufactured when a series of cuts are made along cut lines 17 on a sheet of metal to define a plurality of individual blades 16, 18, 20. Stainless steel is preferred, but any other suitable metal could be used, as long as it is flexible, strong and resists corrosion, rust and heat.

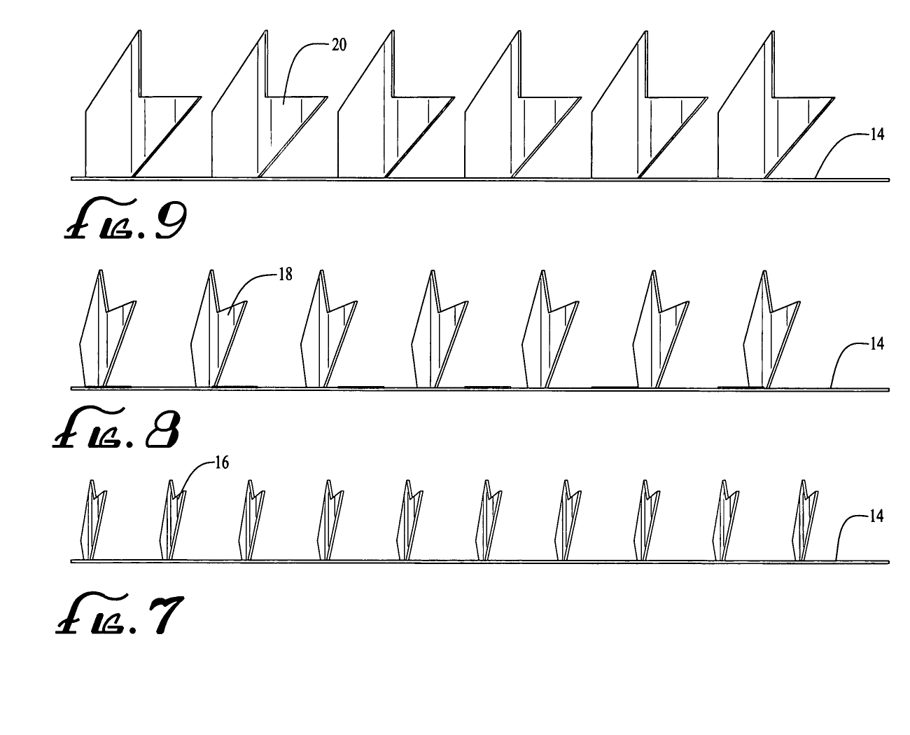

In the embodiment illustrated in the drawings, the blades of the turbine inverter of the invention are arranged in a multi-layer fashion. Referring to FIG. 2, the first layer consists of small blades 16, the second layer consists of medium blades 18, and the third layer consists of large blades 20. Although the turbine inverter of the illustrated embodiment includes three layers of blades, the turbine inverter of the invention can be constructed to include four, five, six or more layers of blades, as necessary. In the illustrated embodiment, the layer of small blades 16 is proximal to the first end 13 of the turbine inverter 10 and the layer of large blades 20 is proximal to the second end 15 of the turbine inverter 10. As seen in FIGS. 2, 4, 5, and 6, although the individual blades 16, 18, 20 are distinct in size and surface area, they are proportionally identical in shape.

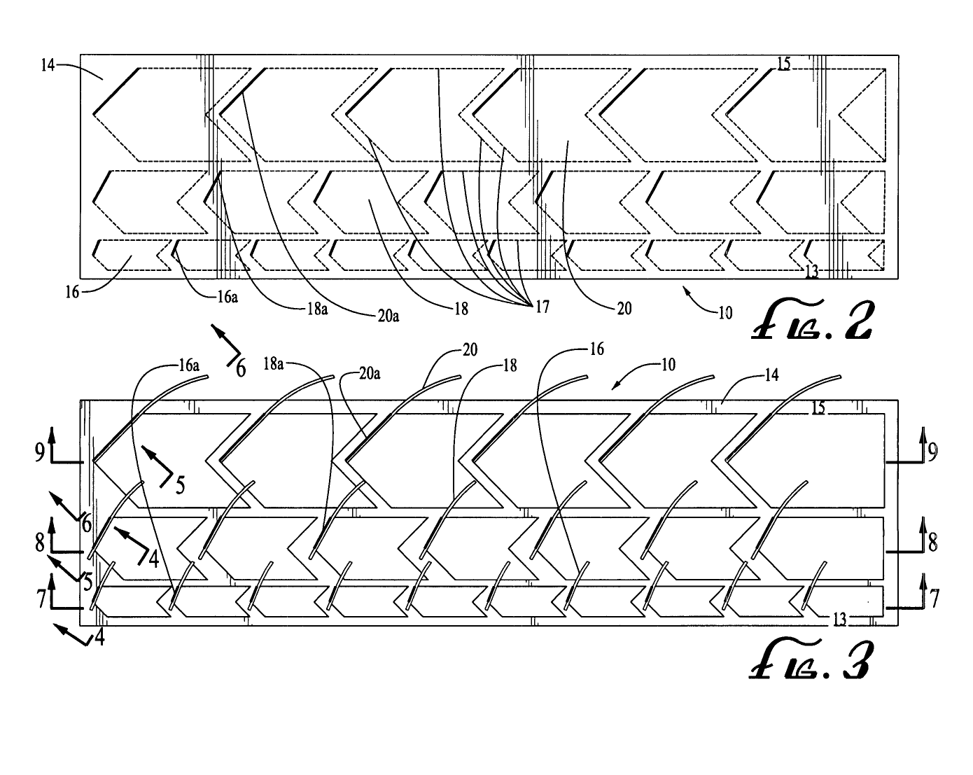

In the embodiment illustrated in the drawings, the blades 16, 18, 20 are six-sided and double-winged in shape, with the wings preferably forming the shape of a “V”. As shown in FIG. 2, the cut lines 17 are made along only five of the six sides in each of the blades. One of the sides 16a, 18a, 20a in each of the blades remains attached to the main body 11. After the cuts are made, the blades 16, 18, 20 are folded inward about their attached sides 16a, 18a, 20a such that the blades project from the interior surface 14 of the turbine inverter 10, as illustrated in FIG. 3. Referring to FIGS. 2 and 3, the attached sides 16a, 18a, and 20a of the blades 16, 18, 20 are oriented at varying angles with respect to the horizontal axis.

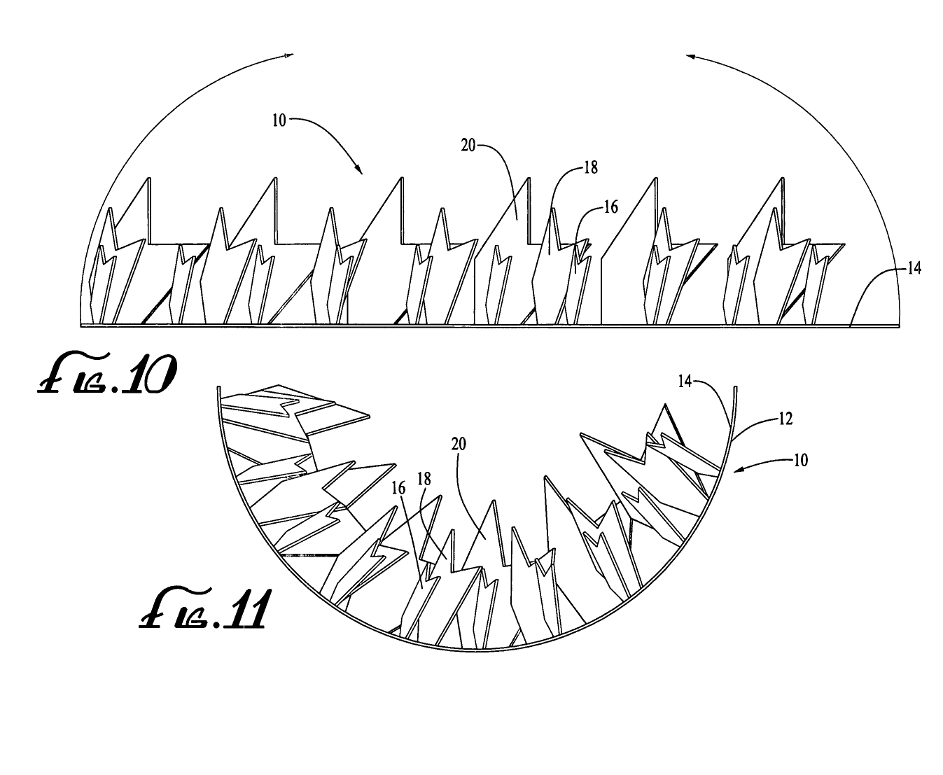

As a result, as seen in FIG. 3, the blades 16, 18, 20 project from the interior surface of the turbine inverter 10 at varying angles with respect to the horizontal axis. Specifically, the layer of small blades 16 (shown in FIG. 7) is oriented at the smallest angle with respect to the horizontal, the layer of medium blades 18 (shown in FIG. 8) is positioned at a larger angle, and the layer of large blades 20 (shown in FIG. 9) is positioned at the largest angle with respect to the horizontal axis. Referring to FIGS. 1 and 3, the blades 16, 18, and 20 are preferably curved at the same diametrical proportion as the interior surface 14 of the main body 11 of the turbine inverter 10. Because the blades 16, 18, 20 are curved, the arrangement of blades in the turbine inverter 10 is referred to as swept-wing design.

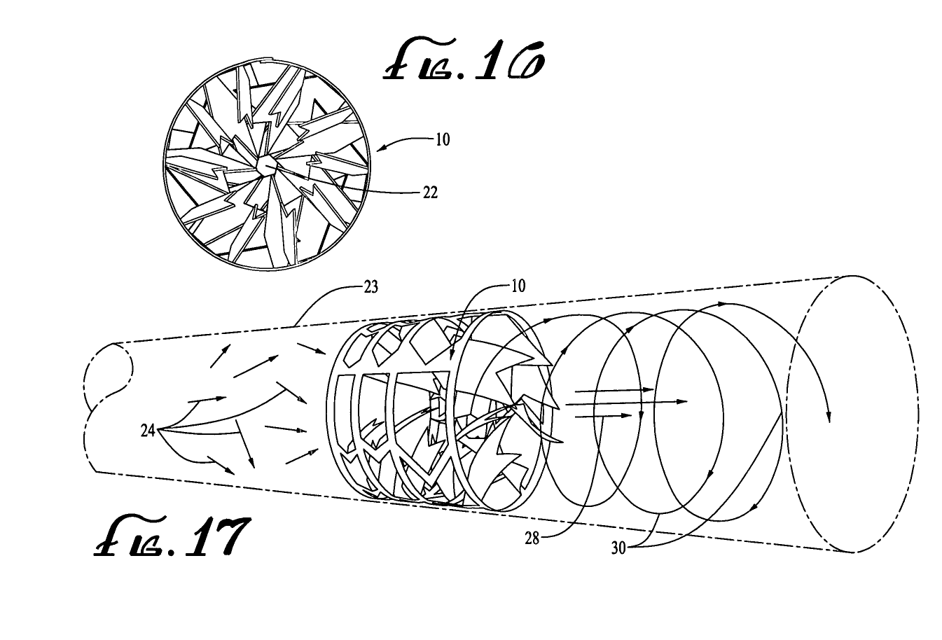

After the blades 16, 18, 20 are folded inward, the two ends of the metal sheet are brought in proximity of each other as shown by the directional arrows in FIG. 10. Referring to FIG. 11, as the ends are moved toward each other, the turbine inverter 10 begins to form its shape in accordance to the medium within which it will be functioning (e.g., circular, cylindrical, elliptical, etc.). FIG. 11 illustrates an end view of the turbine inverter 10 as the circle is approximately halfway complete. FIG. 16 illustrates the turbine inverter 10 of the invention in its final form, after the circle is complete. FIG. 13 illustrates the turbine inverter 10 from the same end view, but shows the orientation of only the small blades 16. Similarly, FIGS. 14 and 15 illustrate the turbine inverter 10 from the same view, but show the orientations of only the medium blades 18 and only the large blades 20, respectively.

Referring to FIG. 16, it can be seen that the blades 16, 18, 20 are cooperatively arranged such that they cover substantially the entire circumference of the turbine inverter 10 and substantially the entire area of the hollow of the main body 11. The center portion 22 of the hollow is not covered by any of the blades 16, 18, 20.

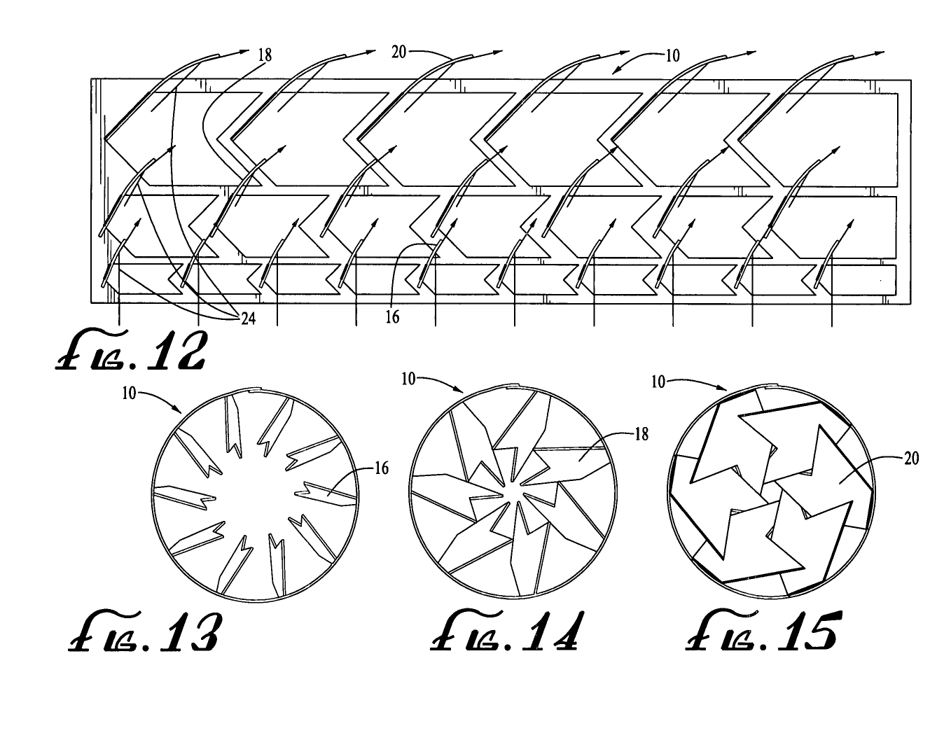

FIG. 17 illustrates the preferred embodiment of the present invention in operation. In operation, the turbine inverter 10 of the invention is inserted into a hose, a pipe, or any other enclosed medium 23 typically used to transport fluids. The turbine inverter 10 is preferably positioned such that fluid 24 enters through the first end 13 of the turbine inverter 10 and exits through its second end 15. As fluid 24 approaches the turbine inverter 10, its flow inside of the enclosure 23 is turbulent because individual fluid particles (not shown) hit each other and bounce off each other and off the enclosement borders at almost every possible direction, as indicated by directional arrows in FIG. 17. As fluid 24 approaches the turbine inverter 10, the friction, drag, and resistance are high. The fluid 24 enters the turbine inverter 10 and is diverted or redirected by the three layers of blades 16, 18, 20 in succession. The blades 16, 18, 20 divert the flowing fluid 24 in accordance to the size, shape and orientation of the blades, as shown in more detail in FIG. 12. As discussed above and as seen in FIG. 12, blades 16 are oriented at the smallest angle to the horizontal, blades 18 are oriented at a larger angle, and blades 20 are oriented at the largest angle to the horizontal. Consequently, as seen in FIG. 12, each successive layer of blades 16, 18, 20 provides a larger entry angle of approach with respect to the fluid 24. Specifically, the layer of blades 16 provides a small entry angle of approach, the layer of blades 18 provides a larger entry angle of approach, and the layer of blades 20 provides the largest entry angle of approach.

In the embodiment of the invention illustrated in the drawings, the shape of the blades 16, 18, 20 is designed to create maximum surface area at the center of the blades, where most of the fluid flow will be diverted. The V-shape formed by the wings of the blades 16, 18, 20 creates a high/low pressure differential as the diverted fluid leaves the blades. Specifically, as fluid is diverted by any given blade, there is a high pressure gradient along each of the two wings, and a low pressure gradient along the middle of the V. As such, the shape of the blade is set to reduce friction, drag and resistance at the angle of fluid entry. The V-shape of the blade greatly reduces the negative pressure buildup referred to as eddy. The swept-wing design of each blade creates a flow and pressure differential as matter leaves each blade layer, resulting in a swirling as well as a pulling effect of matter toward the center of the medium. In addition, as discussed above, each successive blade layer contains an incrementally larger blade size, as well as a larger entry angle of approach, thereby increasing the swirling speed and pulling intensity of the matter through the low pressure.

Referring back to FIG. 17, as the fluid 24 moves through turbine inverter 10, fluid 24 is spun along the medium by that increasing the swirling speed and pulling intensity of the matter through the device diameter limits due to high pressure flow. Along the proximal diameter of the turbine inverter 10, the fluid flow 28 is more linear due to lower pressure flow. Along the center, there is a very low pressure resulting in a more linear flow 28. Because there is a high pressure fluid flow 30 proximally to the interior surface 14 of the turbine inverter 10 and a very low pressure linear flow 28 at the center, a pull of matter from high to low pressure occurs, and there is a creation of uniform pull of matter forward and towards the center.

Accordingly, there is an increase in flow due to decreased turbulence, decreased resistance and drag and due to an increased uniform flow and an increased pull from high to low pressure area. Because the fluid flow is less turbulent and more laminar as the fluid comes out of the turbine inverter, the power of a pump or a motor required to move the fluid through the pipe or hose is lower. Similarly, if the pump is left at the same power level, a larger amount of fluid moves through the pipe/hose when the turbine inverter of the invention is utilized. Thus, there is provided a device which, when inserted into any enclosed medium, provides an increase in the efficiency of flow.

Although three layers of blades are used in the preferred embodiment of the present invention, the number of blade layers may be adjusted in order to make a turbine inverter of any required size. Also, the blades do not have to be sized and oriented in exactly the way illustrated in the drawings. In fact, the amount of successive layers of blades, the size and shape of the blades, and the approach angle may be varied in accordance with at least the following factors: the diameter of the enclosed medium, the velocity of fluid flow, and the temperature, viscosity, and molecular weight of the fluid moving through the enclosed medium. In addition, depending on the length of the enclosed medium, not one, but a plurality of turbine inverters may be placed at predetermined spaced intervals along the enclosed medium to effectively achieve the objectives of the present invention.

Although particular embodiments of the invention have been described and illustrated herein, it is recognized that modifications and variations may readily occur to those skilled in the art, and consequently it is intended that the claims be interpreted to cover such modifications and equivalents.

I claim:

1. A device for directing fluid flow within an enclosed medium comprising:
a main body having a hollow cavity and an interior surface;
a plurality of curved blades arranged in a spaced relationship about the interior surface of the main body, said plurality of blades projecting inwardly from said interior surface into said hollow cavity of the main body;
said blades being arranged in a plurality of layers, the blades in each consecutive layer having an incrementally larger surface area than blades of a preceding layer; and
wherein said plurality of layers of blades being adapted to encounter a flowing fluid in succession and directing the flow of said fluid.

2. The device of claim 1, wherein the blades in each consecutive layer have an incrementally larger entry angle of approach than blades of a preceding layer.

3. The device of claim 1, wherein all of said blades are proportionally identical in shape.

4. The device of claim 1, wherein the blades are curved at the same diametrical proportion as the enclosed medium.

5. The device of claim 1, wherein said main body is generally cylindrical.

6. A device for directing fluid flow within an enclosed medium comprising:
a main body having a hollow cavity and an interior surface;
a plurality of curved blades arranged in a spaced relationship about the interior surface of the main body, said plurality of blades projecting inwardly from said interior surface into said hollow cavity of the main body;
said blades being arranged in a plurality of layers, the blades in each consecutive layer having an incrementally larger entry angle of approach than blades of a preceding layer;
said plurality of layers of blades being adapted to encounter a flowing fluid in succession and directing the flow of said fluid.

7. The device of claim 6, wherein the blades in each consecutive layer have an incrementally larger surface area than blades of a preceding layer.

8. The device of claim 6, wherein all of said blades are proportionally identical in shape.

9. The device of claim 6, wherein the blades are curved at the same diametrical proportion as the enclosed medium.

10. The device of claim 1, wherein said main body is generally cylindrical.

11. A device for directing fluid flow within an enclosed medium comprising:
a main body having a hollow cavity and an interior surface;
a plurality of curved blades arranged in a spaced relationship about the interior surface of the main body, said blades projecting inwardly from said interior surface into said hollow cavity of the main body;
a first layer of said curved blades, the blades of said first layer having a surface area and an entry angle of approach;
a second layer of said curved blades, the blades of said second layer having a larger surface area and a larger entry angle of approach than the blades of said first layer;
a third layer of said curved blades, the blades of said third layer having a larger surface area and a larger entry angle of approach than the blades of said second layer;
said first, second and third layers of curved blades being adapted to encounter a flowing fluid in succession and directing the flow of said fluid.

12. The device of claim 11, wherein all of said blades are proportionally identical in shape.

13. The device of claim 11, wherein the blades are curved at the same diametrical proportion as the enclosed medium.

14. The device of claim 11, wherein said main body is generally cylindrical.

15. A method of directing fluid flow within an enclosed medium comprising the steps of:
providing at least one device, said device comprising a main body having a hollow cavity and an interior surface; a plurality of curved blades arranged in a spaced relationship about the interior surface of the main body, said blades projecting inwardly from said interior surface into said hollow cavity of the main body; said blades being arranged in a plurality of layers, the blades in each consecutive layer having an incrementally larger surface area and larger entry angle of approach than blades in a preceding layer; said plurality of layers of blades being adapted to encounter a flowing fluid in succession and directing the flow of said fluid;
placing at least one said device into said enclosed medium;
wherein said at least one device is capable of decreasing the turbulence of flow of said fluid within said medium.

16. The method of claim 15, further comprising the step of providing a plurality of said devices, the plurality of said devices being positioned at predetermined intervals within said medium.
